(19) United States
(12) Patent Application Publication
(10) Pub. No.: US 2026/0300520 A1
(43) Pub. Date: Oct. 1, 2026

(54) METHOD AND DEVICE FOR SECURE DEVICE-TO-DEVICE COMMUNICATION

(71) Applicant: Telefonaktiebolaget LM Ericsson (publ), Stockholm (SE)

(72) Inventors: Tommy ARNGREN, Sodra Sunderbyn (SE); Peter ÖKVIST, Lulea (SE); Niklas LINDSKOG, Lund (SE)

(21) Appl. No.: 19/477,031

(22) PCT Filed: Apr. 20, 2023
(86) PCT No.: PCT/SE2023/050365

§ 371 Date: Oct. 20, 2025

(51) Int. Cl. G06F 21/60; G06F 3/01

(52) U.S. Cl. CPC G06F 21/606; G06F 3/016

(57) ABSTRACT

A method for secure device-to-device communication between a first device and a second device is disclosed. Each device comprises a respective surface enabled for haptic interaction involving tactile interaction. The method is performed in the first device and comprises initiating a haptic interaction with the second device and communicating with the second device by means of the haptic interaction between the devices. A corresponding device, computer program and computer program product are also provided for secure device-to-device communication.

### TECHNICAL FIELD

The technology disclosed herein relates generally to the field of secure communication and in particular to a method and a device for secure communication between devices.

### BACKGROUND

Radio signals may be eavesdropped basically irrespectively of how low power is used in a transmission, provided that an eavesdropper has suitable detector antenna area, receiver sensitivity and processing power. Essentially all radio-based solutions are susceptible to relay and/or replay attacks and requires protocol-based countermeasures for protection against such attacks. Hence, in order to obtain high security without protocol-based solutions, the communication should not involve radio signaling. However, there are various situations and use cases in which a user still needs to communicate by means of the communication device. One example of such situation is when the user is in a strictly radio-silent environment, another is in covert applications. The devices may also need to perform authentication and handshaking without using the radio signaling.

A known way of transferring information between, for instance, smart devices is by vibration-pattern communication. The smart devices then have built-in vibrator and accelerometer, and a transmitting device sends a sequence of vibrations. The vibrations propagate through an object (e.g., a table) on which the communicating smart devices are placed. The receiving device analyzes its accelerometer readings and is then able to decode the incoming messages. This method may be a viable alternative communication method when general types of radio communication methods are not available.

Another known way is to use Visible Light Communication (VLC). In such communication, light is emitted from a Light Emitting Diode (LED) of a sending device through rapid light modulation. This light is received by a receiving device, which translates the received light into usable data.

These known methods have several drawbacks. The vibration-pattern communication requires an object on which to place the devices on, which might not always be readily available. The VLC communication may be eavesdropped, just like radio communication.

Authentication information shared on a screen can be overseen despite efforts hide it, but if one intended viewer can see the information, others may in principle also see it, and some additional layer of data obfuscation is required. Similar to screen information being shared, authentication information carried with audio and/or voice may be overheard.

From the above, it is clear that there is a need for improvements in view of security in exchanging sensitive information between devices.

### SUMMARY

An objective of embodiments herein is to address and improve various aspects relating to information exchange between two devices. A particular objective is to enable a highly secure communication between two devices without using radio signalling or other wireless transfer or related ports. Another objective is to eliminate or at least highly reduce risks of eavesdropping a communication between two communication devices. Still another objective is to eliminate risk of information being overseen or intentionally viewed. These objectives and others are achieved by the methods, devices, computer programs and computer program products according to the appended independent claims, and by the embodiments according to the dependent claims.

According to a first aspect there is presented a method for secure device-to-device communication between a first device and a second device. Each device comprises a respective surface enabled for haptic interaction involving tactile interaction. The method comprises initiating, by the first device, a haptic interaction with the second device, after which the first device and the second device are able to communicate with each other by means of the haptic interaction between the devices.

The method is applicable in many use cases, such as, for instance, for transferring sensitive information, e.g., cryptographical keys, or for authentication using a shared pattern.

In an embodiment, the communication comprises the first device and the second device exchanging data by haptic interaction, wherein the haptic interaction comprises one or both of protrusions and indentations.

According to a second aspect there is presented a computer program for secure device-to-device communication between a first device and a second device. The computer program comprises computer code which, when run on processing circuitry of a device, causes the devices to perform a method according to the first aspect.

According to a third aspect there is presented a computer program product comprising a computer program as above, and a computer readable storage medium on which the computer program is stored.

According to a fourth aspect there is presented a device for secure device-to-device communication between a first device and a second device. The first device comprises a surface enabled for haptic interaction. The first device is configured to initiate a haptic interaction with the second device and communicate with the second device by means of the haptic interaction between the first and second devices.

Advantageously, these aspects enable a highly secure way of communicating by means of various types of user equipment, including wireless communication devices implementing the herein presented teachings. These aspects provide a highly secure way for two devices to communicate without using radio signalling or other wireless transfer or related ports. Further, the risk of eavesdropping on a communication between two devices is eliminated or at least rendered very low. Still further, the risk of information being overseen or intentionally viewed is eliminated.

Other objectives, features and advantages of the herein described embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise. The actions of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 shows schematic drawings illustrating devices according to embodiments.

FIG. 2 is a flowchart illustrating various embodiments of a method.

FIG. 3 is a schematic diagram showing functional units of a device according to an embodiment.

FIG. 4 is a schematic diagram showing functional modules of a device according to an embodiment.

FIG. 5 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any action or feature illustrated by dashed lines should be regarded as optional.

In this description, “haptic” is used in the following sense: a first surface rendering a physical topological protrusion out of a plane of the first surface, and the inversed mechanism where another, second surface may sense presence of a physical protrusion onto the surface. In a general sense, the wording “haptic” may be considered in terms of “tactile interactions” or “touch”; herein the word may include above “surface's physical protrusion” but also a “touch” aspect where a surface may render a virtual touch-signal (not perceptible by human touch-sensing senses) in the sense that a first surface generates e.g. a specific grid-pattern based on different concentration/densities of electrical charge that a second surface may detect accordingly. This non-human-perceptible aspect of “touch” may also be included in the present definition of “haptic”.

Further, the wording “haptic” is herein not considering haptic in the sense that a human manually (by e.g., hand) shakes something, or that a user bumps/knocks one device onto some other object, surface or device to render an Inertia Measurement Unit (IMU) signal, nor that a device may render “a haptic signal” in terms of activating its vibrational functions (e.g., step engines along several device's axis with asymmetrical rotational weights, etc.) which is conveyed to another device.

A method and devices are provided, wherein the method enables two or more devices to securely communicate with each other without using radio signaling or other wireless transfer or using corresponding ports.

The present teachings provide an alternative to conventional methods to transfer sensitive information. One such conventional method is to set up a session key and transfer data over some type of medium. As described earlier, this and other conventional methods may easily be eavesdropped on. The sensitive information may, for instance, comprise cryptographical keys and capability tokens, e.g., giving a device authorization to perform a certain action on another device's behalf.

An example on a specific use case for which the herein presented method and device are advantageous, is the case when there is a need to transfer tokens from one device to another, e.g., from your mobile phone to your smart watch. One topology in which such token may be needed in is a Personal Area Network (PAN). The user may then physically put his watch and the mobile phone together. By enabling haptic transfer, secret tokens can be transferred with highly reduced risk of eavesdropping and without need for encryption. To exemplify, the user may submit fingerprint to a biometric sensor on his mobile phone; the smart watch may then receive the fingerprint through haptic transfer. The transferred fingerprint may unlock the watch without the watch having its own biometric sensor. Further exemplary use cases are given later.

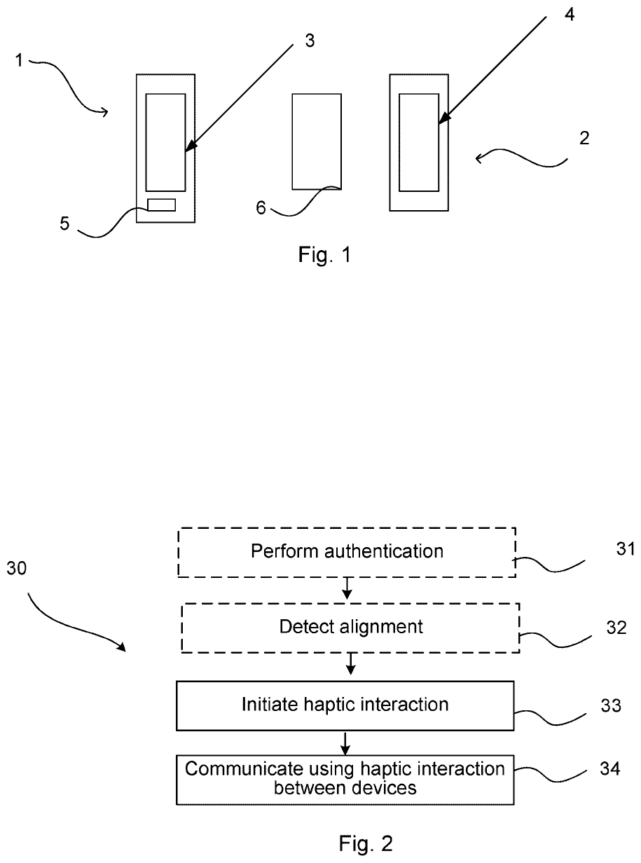

FIG. 1 illustrate schematically devices according to embodiments. A first device 1 and a second device 2 are illustrated. The first and second devices 1, 2 may, for instance, be a device for wireless radio communication, such as a smart phone. Both devices 1, 2 are provided with a respective screen 3, 4 and/or haptic surfaces for use in creating a secure communications channel. The communication channel comprises using a pattern of protrusions and indentations: the first device 1 provides a pattern of protrusions and indentations on its screen 3, which is enabled for haptic interaction, and the second device 2 senses this pattern by means of its screen 4, which is also enabled for haptic interaction.

In some embodiments, the device 1, 2 is provided with two displays. One display 3 may be for conventional use, such as scrolling in a web browser, using apps etc., while the other display 5 comprises the haptic surface used as communication channel for secure communication. In still other embodiments, the device 1, 2 may comprise multiple separate haptic (tactile/touch) surfaces to enable simultaneous touch-based interactions with two or more devices.

The haptic display 3, 4 may comprise, at least partly, an Electro Active polymer (EAP) surface. The EAP surface is one example on how to enable the screen 3, 4 for haptic interaction, i.e., the EAP layer enables the display to create the pattern of protrusions and indentations. Another example on such surface is a braille display.

The secure communication channel between the first and second devices 1, 2 can be established when the devices 1, 2 are brought sufficiently close to each other, which closeness is dependent on the size of protrusions and/or indentations that are created during the communication. The two devices 1, 2 then utilize their respective screens 3, 4 (or alternative haptic surface 5) for the secure communication.

The two devices 1, 2 may initiate or trigger the secure communication by any known method, e.g., by touching each other, for instance, by bumping together, which may activate the EAP layer of the respective haptic surface 3, 4 of the devices 1, 2. Further examples on triggers to use, in addition to or instead of the mentioned examples, for determining that the two devices 1, 2 are in the same environment, is to use acoustics and/or light spectrum characteristics. For instance, light flicking of a Light Emitting Diode (LED) may be detected simultaneously by the two devices 1, 2. Still further examples on triggers for pattern matching between the two (or more) devices 1, 2 comprise electric and/or magnetic strength sensor, barometric sensors, biochemical sensors, gas sensors, radiometry etc. These exemplary triggers may be used in combination or separately, depending on e.g., security aspects.

After the initiation, an alignment of the devices 1, 2 is performed, wherein the surfaces of the respective devices are placed so that the haptic surface of the respective devices 1, 2 are aligned in such a way that the secure communication can be effectuated. The alignment may, for instance, be performed using haptics, e.g., Inertia Measurement Unit (IMU), in order to ensure that orientation of the devices 1, 2 (up/down) are synchronized. Once initiated, the secure communication then uses the protrusions and indentations to exchange data.

In various embodiments, the communication 34 comprises the first and second devices 1, 2 communicating through a tactile surface or through a third device 6 enabled for the haptic interaction. That is, the tactile surface or the third device conveys the haptic interaction between the first and second devices 1, 2, e.g., receives protrusions and/or indentations from the first device 1 and forwards them to the second device 2. The tactile surface or the third device 6 may perform the haptic interaction with the first and second devices 1, 2 by being in proximity of the first and second devices or by having physical contact with the respective surfaces of the first and second devices 1, 2.

A first and a second device 1, 2, are both provided with a respective haptic surface. As a first step, they intend to pair, authenticate or perform a handshake. For this to be possible, the devices 1, 2 has to be sufficiently close to each other, as described earlier. The first device 1 invokes haptic transfer mode. This can be done by the user in different ways, e.g., by using an application (“app”) in the device 1, or by an Inertial Measurement Unit (IMU) pattern matching, e.g., flipped and “something”-pattern. For instance, the user may invoke the haptic transfer mode by starting an app on his device 1, 2 and then invoke the haptic transfer mode by doing a gesture with the device which is detected by the IMU. There are various options to start by haptic transfer mode, tap a pattern on the device which the IMU detects, or by using a camera or microphone to start the app.

The haptic transfer mode may be announced from the first device 1 to the second device 2 via out-of-band (OOB) communication, or simply verbally user to user, by bump, IMU pattern or gesture, or by any other non-radio signaling methods.

Thereafter, the first and second devices 1, 2 are put together and aligned. The alignment mechanism itself may use certain haptic-surface protrusion patterns, such as specific areas, segments, patches, etc., may be selected as “fence-poles” which must be sustained, i.e., holding an uninterrupted touch during the entire communication session.

The first device 1 initiates a first haptic sequence, which in the application of the first device 1 is identified as a service request.

A haptic random sequence pattern e.g., in terms of a haptically protruded “QR code” (QR=Quick Response) or similar, is rendered at a display or haptic surface of the first device 1, for instance, by using Electro Active Polymer (EAP) in the display/haptic surface.

The second device 2 prepare its screen or haptic surface for receiving haptic input, it allows the service request, and responds with an acknowledgment (ACK) message. The second device 2 then enters a wait-read mode.

The first device 1 selects a haptic sequence and renders it on its haptic surface.

The second device 2 scans the screen/haptic surface of the first device 1 for haptic input. The second device 2 then translates the found haptic input and translates this haptic input to binary data and writes it to a temporary storage.

If the communication is to be performed in both directions, i.e., the second device 2 wants to reply to the message from the first device 1, then the second device 2 scans the haptic surface for haptic input.

The second device 2 translates haptic input to binary data and writes it to temporary storage. Second device responds to first device with detected sequence executed with same time constant as recorded from readout of its own haptic receive surface.

The first device 1 scans the display or haptic surface for haptic input. The first device 1 then translates the scanned haptic input to binary data and writes it to a temporary storage.

If the communication is only in one direction, the second device 2 simply reads or decodes the first haptic sequence (from 1-n sequences) generated on the screen or surface of the first device 1 and may respond with ACK, haptic or OOB until End of Data (EOD) is determined.

Besides the earlier given exemplary use case, the present teachings may be applied in numerous other cases. A second exemplary use case is to perform an authentication by using a shared pattern. In this use case, the haptic sequence may a predetermined authentication pattern, similar to a user's screen unlocking sequence. In order to make human replication challenging or even impossible, a protrusion pattern may preferably be selected and generated with more touchpoints than number of fingers and/or protrusion area smaller than an area threshold.

The response from the second device 2 determines if the pattern is valid and indeed belongs to the first device 1. If valid, the second device 2 may respond with a response pattern (if the devices have mutually authenticated each other), with an ACK or with the same pattern in return as was received. If not valid, the second device 2 may respond with a Negative ACK (NACK) sequence, the same pattern in return or simply not respond at all.

The first device 1 reads the haptic input and either performs evaluation of the response pattern or determines if the authentication was successful.

As a third use case authentication can be made using challenge and a shared secret. In this use case the haptic sequence is a random challenge which is utilized for authentication. The response from the second device 2 may in this case be a combination of the received random challenge and a shared secret between the first device 1 and the second device 2. For instance: response=OWF(challenge, secret), wherein OWF=One Way Function. Alternatively, or additionally, the second device 2 may have received and stored patterns in advance and may use the received challenge in order to select one of the stored patterns. The first device 1 then compares the read haptic input with the expected input. If correct, i.e., if the haptic input equals the expected input, the first device 1 may then determine that that second device 2 is indeed the intended device.

As a fourth exemplary use case, the haptic random sequence may be considered in terms of e.g., a haptically protruded QR code, grid board or barcode, or the like. The haptic sequence may also be selected in “free form”, such as an arbitrary scribble rendered over surface area, or a user-provided whatever-finger-swipe pattern.

Protrusion depth may not only be rendered binary as “no bump/bump” [0 1], but also as a three level [0 0.5 1] setup to increase the number of information transfer rate. Depending on haptic surface protrusion rendering capabilities, several protrusion levels may apply.

FIG. 2 is a flowchart of various embodiments of a method. The method may be used for establishing a secure communication channel between two or more devices 1, 2, which communication channel cannot be eavesdropped. The devices 1, 2 comprises a respective surface 3, 4 enabled for haptic interaction, which involves tactile interaction, as has been described.

The method 30 for such secure device-to-device communication between a first device 1 and a second device 2 is performed in the first device 1 and comprises initiating 33 a haptic interaction with the second device 2, and thereafter communicating 34 with the second device 2, by means of the haptic interaction between the devices 1, 2.

The method 30 enables a very secure way to communicate by means of e.g., wireless communication devices, such as smart phones or other devices enabled to communicate in radio access networks. When the method 30 is implemented in devices enabled for wireless communication, the radio signaling means thereof is not involved in the communication. Such radio signaling means may be deactivated while performing the method 30. Two, or in some embodiments three or more, devices are enabled to securely communicate without using radio signalling or other wireless transfer or related ports. Further, the risk of eavesdropping on a communication between devices using the method 30 is in principle eliminated or at least rendered very low. Still further, the risk of information being overseen or intentionally viewed is eliminated.

In an embodiment, the communicating 34 comprises exchanging data with the second device 2 by the haptic interaction, wherein the haptic interaction comprises protrusions and/or indentations, created in and by the first device 1. In some embodiments, the method 30 comprises the first device 1 rendering one or both of the protrusions and indentations in response to user input. The user may input the desired message by, for instance, writing the message using keys of the first device 1. The message may also comprise data in memory or storage, readings from sensors and/or generated data sequences from components within the first device 1. The message is then transformed into the indentations and/or protrusions.

In various embodiments, the communication 34 comprises the first and second devices 1, 2 communicating through a tactile surface or through a third device 6 enabled for the haptic interaction. That is, the tactile surface or the third device conveys the haptic interaction between the first and second devices 1, 2, e.g., receives protrusions and/or indentations from the first device 1 and forwards them to the second device 2. The tactile surface or the third device 6 may perform the haptic interaction with the first and second devices 1, 2 by being in proximity of the first and second devices or by having physical contact with the respective surfaces of the first and second devices 1, 2.

In various embodiments, the communication 34 is effectuated when the surface 3 enabled for haptic interaction of the first device 1 is aligned with the surface 4 enabled for haptic interaction of the second device 2.

In various embodiments, the method 30 comprises, prior to the initiating 32, performing 31 an authentication procedure with the second device 2, and upon successful authentication, detecting 32 alignment of the surface 3 enabled for haptic interaction with the surface 3 enabled for haptic interaction of the second device 2. The authentication procedure may be performed using OOB communication channels or alternatively, using the tactile surfaces for authentication, as described earlier. In the latter scenario, step 31 (performing authentication) may be performed after step 32 (detect alignment).

In various embodiments, the communication 34 is performed in a half-duplex manner. When two devices communicate in such half-duplex manner, they render then and receive, render, receive-etc. In other embodiments, the devices 1, 2 may have disjunct parts of the surface enabled for haptic communication, wherein one part is dedicated for sending, and another part dedicated for receiving. Thereby the devices may operate in full duplex mode.

In various embodiments, the method comprises using the surface 3 enabled for haptic interaction of the first device for alignment with the corresponding surface 4 of the second device 2.

In various embodiments, the initiating 33 comprises the first device 1 sensing a physical contact with the second device 2, while in still other embodiments the initiating 33 comprises receiving a user input requesting the haptic interaction. In yet other embodiments, both user input and sensing may be required.

In various embodiments, and as described earlier, the surface 3, 4 enabled for haptic interaction is a layer of Electro Active Polymer, EAP.

A device 1, 2 is also provided, the device 1, 2 being suitable for secure device-to-device communication between a first device 1 and a second device 2. The device 1, 2 comprises a surface 3, 4 enabled for haptic interaction. The device 1, 2 is configured to initiate a haptic interaction with the second device 2, and to communicate with the second device 2 by means of the haptic interaction between the devices 1, 2.

In an embodiment the device 1, 2 is configured to communicate by exchanging data with the second device 2 by the haptic interaction, wherein the haptic interaction comprising one or both of protrusions and indentations.

In a variation of the above embodiment, the device 1, 2 is configured to render, in response to user input, one or both of the protrusions and indentations.

In various embodiments, the device 1, 2 is configured to communicate when the surface 3 enabled for haptic interaction of the first device 1 is aligned with the surface 4 enabled for haptic interaction of the second device 2.

In various embodiments, the device 1, 2 is configured to, prior to the initiating, perform an authentication procedure with the second device 2, and upon successful authentication, detect alignment of the surface 3 enabled for haptic interaction with the surface 3 enabled for haptic interaction of the second device 2.

In various embodiments, the device 1, 2 is configured to communicate in a half-duplex manner, while in various other embodiments, the device 1, 2 is instead configured to communicate in a full duplex mode using a first surface part dedicated for sending and a second surface part dedicated for receiving.

In various embodiments, the device 1, 2 is configured to use the surface 3 enabled for haptic interaction for alignment with the corresponding surface 4 of the second device 2.

In various embodiments, the protrusions and indentations represent one bit each or several bits wherein the bits are defined by a degree of protrusion and indentation, respectively.

In various embodiments, the device 1, 2 is configured to initiate by sensing a physical contact with the second device 2 or by receiving a user input requesting the haptic interaction.

In various embodiments, the surface 3, 4 enabled for haptic interaction is a layer of Electro Active Polymer, EAP.

In further embodiments, a haptic protrusion handshake sequence may be combined with N-point press-hold alike “fencing” regions, where the first device 1 and the second device 2 in the initial phase establish e.g. four corner fencepole points which must be sustained in an uninterrupted haptic interaction by respective devices 1, 2 during the entire session, and when (or if) less than these four points are detected in haptic interaction, the session is terminated.

In a further aspect, the active/in-use haptically protruded screen or surface area may also be surrounded by a “line of fencepoles” in terms of a “fence line”.

In still a further aspect, with devices 1, 2 that have exchanged protrusion/detection capabilities, the fencepole touch points may be other than binary and static and e.g. be altered over time according to exchanged principles.

In a further aspect, fencepole touch point may be selected randomly for every information transfer session, and a fencepole pattern in previous use may be blocked from upcoming use thereof. This increases the security even further.

In still further embodiments, devices that are equipped with haptic front and back displays and capable of haptically protruded QR code on both sides, may allow several devices to be stacked on top of each other and convey data from the first device 1 to last device n in such stack.

More than two devices, i.e., a set of a first, a second (in-between) device and a third device, may also be subject to haptic authentication and data transfer. In that, the second (in-between) device may indicate to first device that a third device is piggybacking the second (in-between) device.

In communication intended for a third device, a segment of the QR-rendering area may be associated with an address field indicating intended recipient of the haptic transmission, e.g., as “recipient: second device”, “recipient: third device”, or “recipient: second and third device”. In a general solution, there may be two and more in-between devices between a first and a last device.

In a scenario wherein data is intended for only the third device, the first and the third devices may, in preceding steps, exchange means for encrypting data so that a less trusted second in-between device may not have the possibility to eavesdrop on transferred data. Alternatively, assuming that the second device is still trusted, devices may define a second-device-transparent mode where haptically received data at the second device's haptic surface towards the first device is reflected/replicated directly at its haptic surface facing the third device.

Related to the above aspect of segmenting devices, for haptic surfaces to operate in full haptic duplex, some partitions of a reception/transmission area may be associated with direct transfer to a (third) device, either beyond an in-between second one or beside a second device. An in-between device may also act as proxy between two devices in the aspect of acting as a trusted part between two mutually less in-each-other trusting parties.

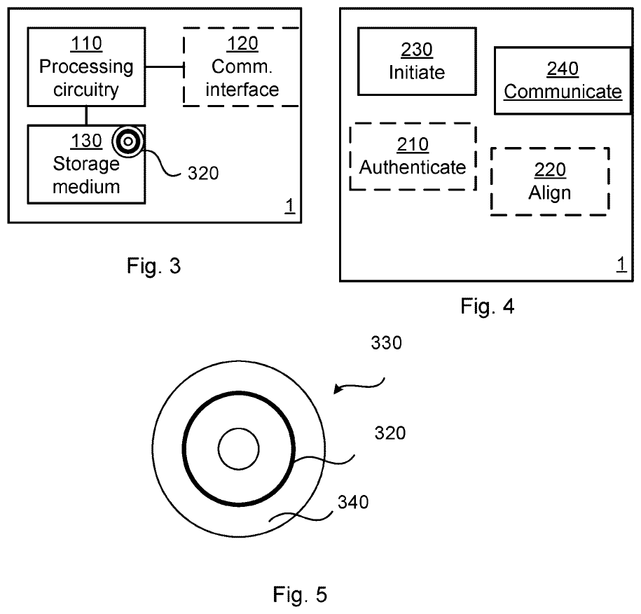

FIG. 3 schematically illustrates, in terms of a number of functional units, the components of a device 1, 2 for establishing a secure communication, as has been described. Processing circuitry 110 is provided using any combination of one or more of a suitable central processing unit (CPU), multiprocessor, microcontroller, digital signal processor (DSP), etc., capable of executing software instructions stored in a computer program product 330 (as shown in FIG. 5), e.g., in the form of a storage medium 130. The processing circuitry 110 may further be provided as at least one application specific integrated circuit (ASIC), or field programmable gate array

### (FPGA).

Particularly, the processing circuitry 110 is configured to cause the device 1, 2 to perform a set of operations, or actions, as disclosed above. For example, the storage medium 130 may store the set of operations, and the processing circuitry 110 may be configured to retrieve the set of operations from the storage medium 130 to cause the device 1, 2 to perform the set of operations. The set of operations may be provided as a set of executable instructions. The processing circuitry 110 is thereby arranged to execute methods as herein disclosed.

The storage medium 130 may also comprise persistent storage, which, for example, can be any single one or combination of magnetic memory, optical memory, solid state memory or even remotely mounted memory.

The device 1, 2 may further comprise a communications interface 120 for communications with other entities, functions, nodes, and devices, over suitable interfaces. As such the communications interface 120 may comprise one or more transmitters and receivers, comprising analogue and digital components.

The processing circuitry 110 controls the general operation of the device 1, 2 e.g., by sending data and control signals to the communications interface 120 and the storage medium 130, by receiving data and reports from the communications interface 120, and by retrieving data and instructions from the storage medium 130. Other components, as well as the related functionality, of the smart contact lens 2 are omitted in order not to obscure the concepts presented herein.

FIG. 4 schematically illustrates, in terms of a number of functional modules, the components of a device 1 according to an embodiment. The device 1 of FIG. 4 comprises a number of functional modules; an initiate module 230 configured to initiate a haptic interaction with another device 2; and a communication module 240 configured to communicate with the other device 2 by means of a haptic interaction between the devices 1, 2. The device 1 of FIG. 4 may further comprise a number of optional functional modules, such as an authenticate module 210 configured to perform an authentication with another device 2; and an align module 220 configured to align the device 1 with another device 2. In general terms, each functional module 210-240 may be implemented in hardware or in software. Preferably, one or more or all functional modules 210-240 may be implemented by the processing circuitry 110, possibly in cooperation with the communications interface 120 and the storage medium 130. The processing circuitry 110 may thus be arranged to from the storage medium 130 fetch instructions as provided by a functional module 210-240 and to execute these instructions, thereby performing any actions of the device 1, 2 as disclosed herein.

FIG. 5 shows one example of a computer program product 330 comprising computer readable means 340. On this computer readable means 340, a computer program 320 can be stored, which computer program 320 can cause the processing circuitry 110 and thereto operatively coupled entities and devices, such as the communications interface 120 and the storage medium 130, to execute methods according to embodiments described herein. The computer program 320 and/or computer program product 330 may thus provide means for performing any actions of the devices 1, 2 as disclosed herein.

In the example of FIG. 5, the computer program product 330 is illustrated as an optical disc, such as a CD (compact disc) or a DVD (digital versatile disc) or a Blu-Ray disc. The computer program product 330 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 320 is here schematically shown as a track on the depicted optical disk, the computer program 320 can be stored in any way which is suitable for the computer program product 330.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for secure device-to-device communication between a first device and a second device, each device comprising a respective surface enabled for haptic interaction involving tactile interaction, the method being performed in the first device and comprising:
initiating a haptic interaction with the second device, and
communicating with the second device by means of the haptic interaction between the devices.

2. The method as claimed in claim 1, wherein the communicating comprises exchanging data with the second device by haptic interaction, the haptic interaction comprising one or both of protrusions and indentations.

3. The method as claimed in claim 2, comprising rendering, in response to user input, one or both of the protrusions and indentations.

4. The method as claimed in claim 1, wherein the communicating comprises the first and second devices communicating through a tactile surface or through a third device enabled for the haptic interaction for conveying the haptic interaction between the first and second devices.

5. The method as claimed in claim 1, wherein the communicating is effectuated when the surface enabled for haptic interaction of the first device is aligned with the surface enabled for haptic interaction of the second device.

6. The method as claimed in claim 1, comprising prior to the initiating:
performing an authentication procedure with the second device and upon successful authentication,
detecting alignment of the surface enabled for haptic interaction with the surface enabled for haptic interaction of the second device.

7. (canceled)

8. The method as claimed in claim 1, wherein the communicating comprises full duplex mode using a first surface part dedicated for sending and a second surface part dedicated for receiving.

9. The method as claimed in claim 1, comprising using the surface enabled for haptic interaction for alignment with the surface of the second device.

10. The method as claimed in claim 1, wherein the initiating comprises one of: sensing a physical contact with the second device and receiving a user input requesting the haptic interaction.

11. The method as claimed in claim 1, wherein the surface enabled for haptic interaction is a layer of Electro Active Polymer, EAP.

12. A device for secure device-to-device communication between a first device and a second device, the device comprising a surface enabled for haptic interaction, and the device being configured to:
initiate a haptic interaction with the second device, and
communicate with the second device by means of the haptic interaction between the devices.

13. The device as claimed in claim 12, configured to communicate by exchanging data with the second device by the haptic interaction, the haptic interaction comprising one or both of protrusions and indentations.

14. The device as claimed in claim 13, configured to render, in response to user input, one or both of the protrusions and indentations.

15. The device as claimed in claim 12, configured to communicate when the surface enabled for haptic interaction of the first device is aligned with the surface enabled for haptic interaction of the second device.

16. The device as claimed in claim 12, configured to, prior to the initiating:
perform an authentication procedure with the second device and upon successful authentication,
detect alignment of the surface enabled for haptic interaction with the surface enabled for haptic interaction of the second device.

17. (canceled)

18. The device as claimed in claim 12, configured to communicate in a full duplex mode using a first surface part dedicated for sending and a second surface part dedicated for receiving.

19. The device as claimed in claim 12, configured to use the surface enabled for haptic interaction for alignment with the surface of the second device.

20. The device as claimed in claim 13, wherein the protrusions and indentations represent one bit each or several bits wherein the bits are defined by a degree of protrusion and indentation, respectively.

21. (canceled)

22. The device as claimed in claim 12, wherein the surface enabled for haptic interaction is a layer of Electro Active Polymer, EAP.

23. (canceled)

24. A computer program product comprising a computer program for secure device-to-device communication between a first device and a second device, and a computer readable storage medium on which the computer program is stored, the computer program comprising computer code which, when run on processing circuitry of the first device and/or the second device, causes the first device and/or the second device to:
initiate, in response to a user action, a haptic interaction with the second device, and
communicate with the second device by means of the haptic interaction between the devices, when the surface enabled for haptic interaction of the first device is aligned with the surface enabled for haptic interaction of the second device.
